(19) United States
(12) Patent Application Publication
(10) Pub. No.: US 2013/0076105 A1
(43) Pub. Date: Mar. 28, 2013

(54) HUBCAP WITH ORNAMENT

(71) Applicant: CHIEN-MING HUNG, TAIPEI CITY (TW)

(72) Inventor: CHIEN-MING HUNG, TAIPEI CITY (TW)

(21) Appl. No.: 13/239,786

(22) Filed: Sep. 22, 2011

(51) Int. Cl. B60B 7/20

(52) U.S. Cl. 301/37.25

(57) ABSTRACT

A hubcap with ornament includes a covering member for mounting to an outer side of a wheel rim on a car; a connecting unit fixedly connected to one face of the covering member; and an ornament movably connected to the connecting unit. When the covering member of the hubcap rotates along with the wheel rim, the ornament, even if it is in a slightly vibrating state, can maintain its original position without rotating along with the covering member and the wheel rim, and can therefore clearly show its beautiful appearance all the time.

### FIELD OF THE INVENTION

The present invention relates to a hubcap, and more particularly to a hubcap having an ornament movably connected thereto via a connecting unit, so that the ornament does not rotate when the hubcap rotates along with a wheel rim and clearly shows its beautiful appearance all the time.

### BACKGROUND OF THE INVENTION

FIG. 1 shows a conventional hubcap that includes a covering member 5 and an ornament 6 associated with the covering member 5. When the covering member 5 is mounted to an outer side of a wheel rim 7 on a car, as shown in FIG. 2, the ornament 6 with a beautiful appearance can decorate the car.

Since the ornament 6 is fixedly connected to one face of the covering member 5, it would rotate along with the covering member 5 and the wheel rim 7 when the car is moving. The ornament 6 rotating quickly along with the hubcap becomes a vague image that could not be clearly recognized and therefore has largely reduced ornamental effect.

It is therefore tried by the inventor to develop an improved hubcap with ornament to eliminate the drawback in the conventional hubcap, so that the ornament provided on the hubcap can always clearly show its beautiful appearance to achieve good ornamental effect.

### SUMMARY OF THE INVENTION

A primary object of the present invention is to provide an improved hubcap, which is mounted to an outer side of a wheel rim on a car and has an ornament movably connected thereto. Therefore, when the hubcap rotates along with the wheel rim, the ornament will only vibrate slightly but maintain its original position without rotating along with the hubcap, and can therefore always show its beautiful appearance and achieve the ornamental effect even when the car is moving.

To achieve the above and other objects, the hubcap with ornament according to the present invention includes a covering member for mounting to a wheel rim on a car, a connecting unit connected to one face of the covering member, and an ornament movably connected to the connecting unit.

In an embodiment of the present invention, the connecting unit includes a screw bolt extended through the covering member, a rotating element connected to an end of the screw bolt, and a nut connected to another opposite end of the screw bolt; and the ornament is associated with the rotating element.

According to an embodiment, the covering member can be made of a metal or a non-metal material.

According to an embodiment of the present invention, the rotating element is a bearing.

According to an embodiment of the present invention, the screw bolt has washers fitted thereon, and the washers are located at two opposite sides of the covering members.

In an embodiment of the present invention, the ornament is associated with the rotating element by bonding, welding or coupling it to the rotating element.

In an embodiment of the present invention, the ornament can be shaped as any one of an animal, a plant, a numeral, a character, and a geometrical pattern.

With the present invention, the covering member of the hubcap is mounted to an outer side of a wheel rim on a car, and the ornament is movably connected to one face of the covering member via the connecting unit. In this manner, when the hubcap rotates along with the wheel rim, the ornament will only vibrate slightly but maintains its original position without rotating along with the hubcap, and can therefore always show its beautiful appearance and achieve the ornamental effect even when the car is moving.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional hubcap;

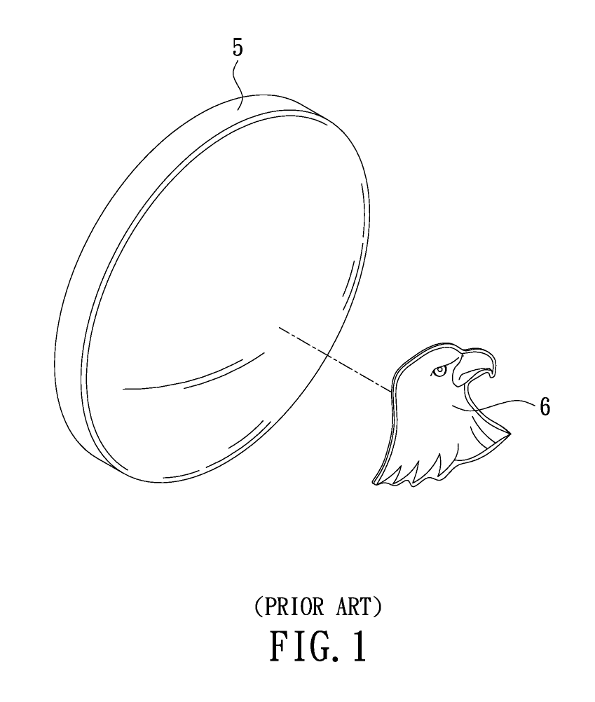

FIG. 2 shows the conventional hubcap in use;

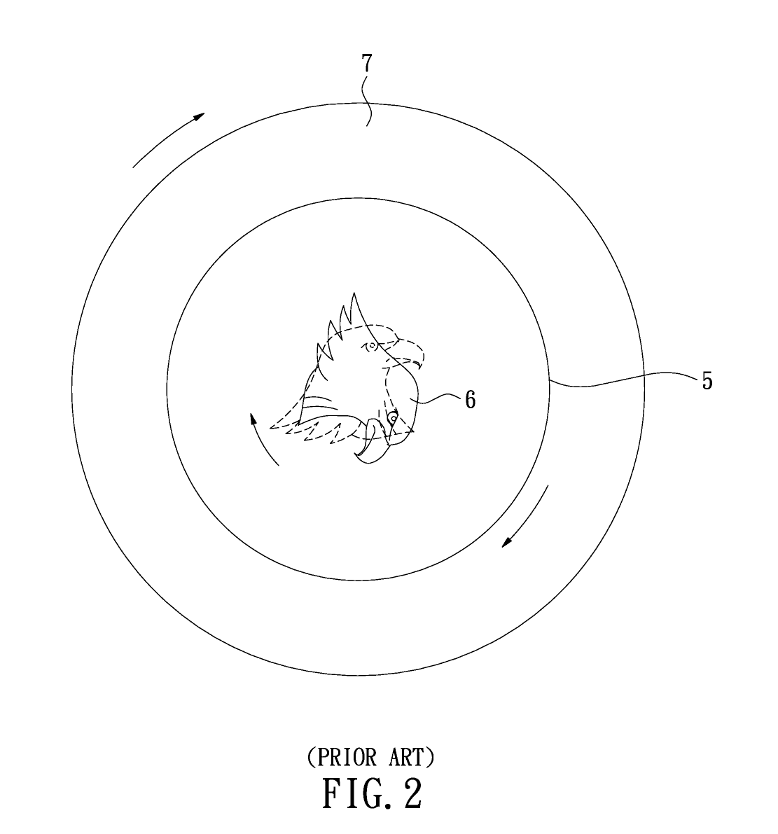

FIG. 3 is an exploded perspective view of a hubcap with ornament according to a preferred embodiment of the present invention;

FIG. 4 shows the manner of mounting the hubcap of the present invention to a wheel rim;

FIG. 5 shows the hubcap with ornament according to the present invention in use;

FIG. 6 is a sectional side view of the hubcap with ornament according to the present invention; and

FIG. 7 is an enlarged view of the circled area “a” in FIG. 6.

### DETAILED DESCRIPTION OF THE PREFERRED EMBODIMENTS

The present invention will now be described with a preferred embodiment thereof and with reference to the accompanying drawings.

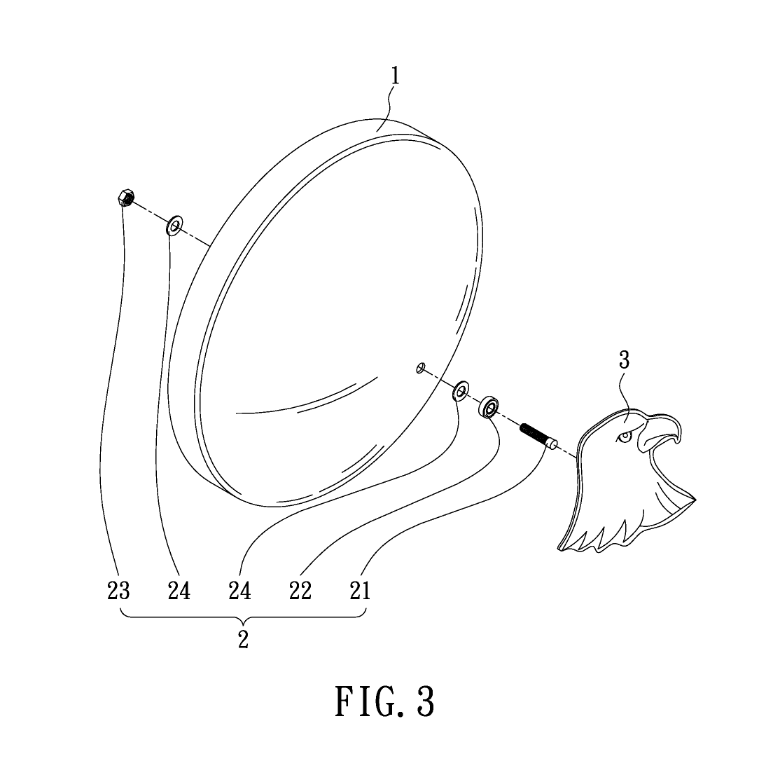

Please refer to FIG. 3 that is an exploded perspective view of a hubcap with ornament according to a preferred embodiment of the present invention. As shown, the hubcap according to the present invention includes a covering member 1, a connecting unit 2, and an ornament 3.

The covering member 1 can be made of a metal or a non-metal material.

The connecting unit 2 is provided on one face of the covering member 1, and includes a screw bolt 21 extended through the covering member 1, a rotating element 22 connected to an outer end of the screw bolt 21, and a nut 23 connected to an opposite inner end of the screw bolt 21. The rotating element 22 can be a bearing. Washers 24 are fitted on the screw bolt 21 and are located at two opposite sides of the covering member 1.

The ornament 3 is associated with the rotating element 22 of the connecting unit 2 to thereby maintain a movable state relative to the covering member 1 of the hubcap. The ornament 3 can be associated with the rotating element 22 by way of bonding, welding or coupling it to the rotating element 22. Further, the ornament 3 can be shaped as any one of an animal, a plant, a numeral, a character, and a geometrical pattern.

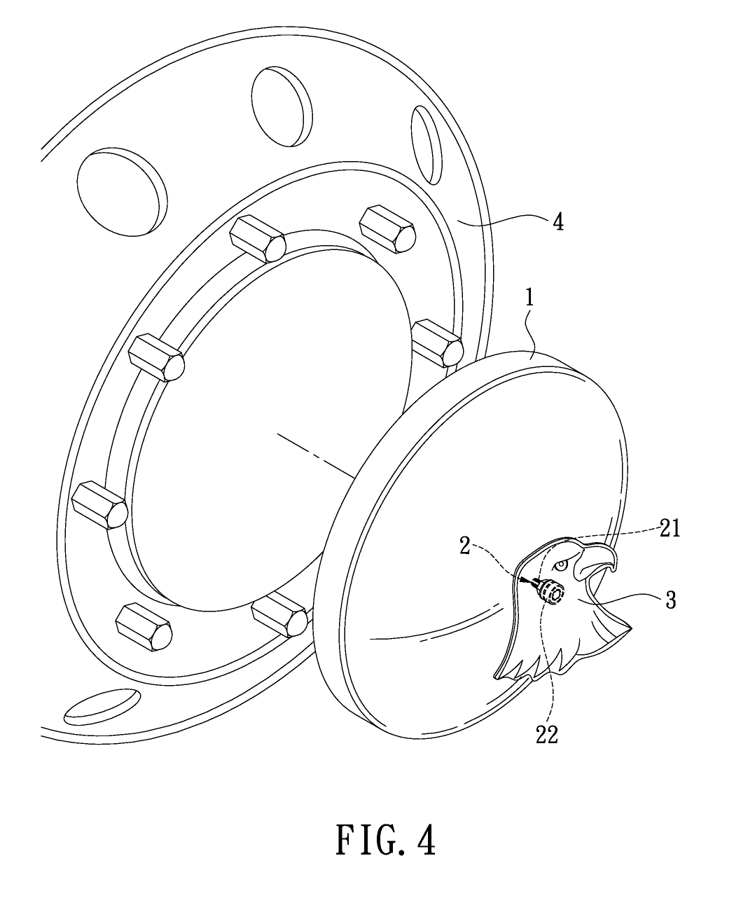

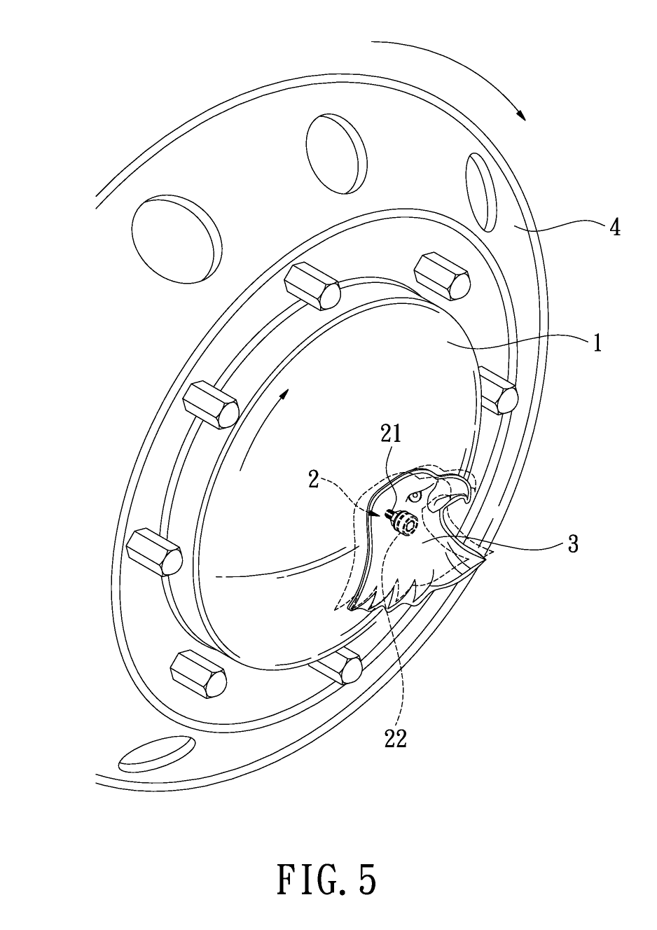

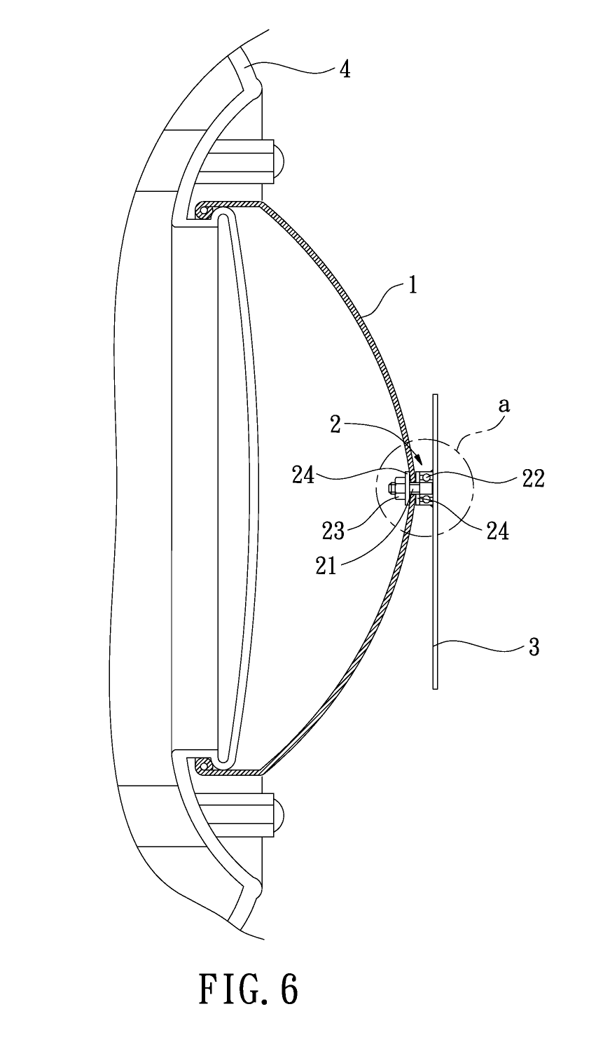

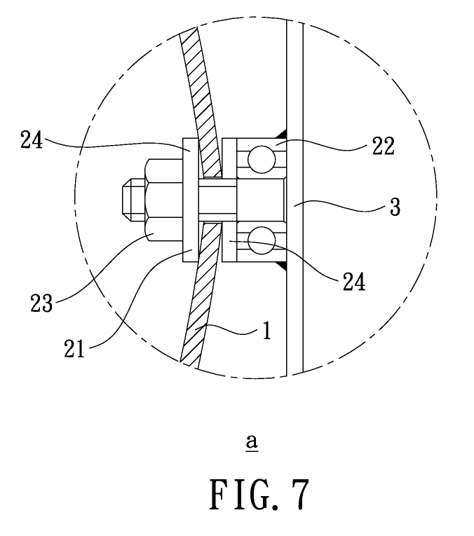

FIG. 4 shows the manner of mounting the hubcap of the present invention to a wheel rim; FIG. 5 shows the hubcap with ornament according to the present invention in use; FIG. 6 is a sectional side view of the hubcap with ornament according to the present invention; and FIG. 7 is an enlarged view of the circled area “a” in FIG. 6. Please refer to FIGS. 4 through 7. To use the hubcap with ornament according to the present invention, just mount the covering member 1 to an outer side of a wheel rim 4 on a car. When the wheel rim 4 rotates, the covering member 1 of the hubcap is brought to rotate at the same time. Since the screw bolt 21 of the connecting unit 2 is extended through the covering member 1 and fixedly held thereto by the nut 23 and the washers 24, the screw bolt 21 will rotate along with the covering member 1 when the latter rotates. On the other hand, the ornament 3 is associated with the rotating element 22 of the connecting unit 2 to thereby maintain a movable state relative to the covering member 1 due to the rotatable property of the rotating element 22. Thus, when the covering member 1 of the hubcap rotates along with the wheel rim 4, the ornament 3 connected to the rotating element 22 can remain its original position relative to the covering member 1. While the ornament 3 might vibrate slightly, it would not rotate along with the covering member 1. In this manner, the ornament 3 can still clearly show its beautiful appearance to achieve good ornamental effect even when the car is moving.

With the above arrangements, the hubcap with ornament according to the present invention is novel, improved and industrially valuable. The present invention is novel and improved because the ornament connected to an outer surface of the covering member of the hubcap via the connecting unit is movable relative to the covering member, such that the ornament, even if it is in a slightly vibrating state, can maintain its original position without rotating along with the covering member and the wheel rim, and can therefore clearly show its beautiful appearance all the time. The present invention is industrially valuable because products derived from the present invention would no doubt satisfy the current market demands.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A hubcap with ornament, comprising a covering member for mounting to a wheel rim on a car; a connecting unit being connected to one face of the covering member; and an ornament being movably connected to the connecting unit.

2. The hubcap with ornament as claimed in claim 1, wherein the connecting unit includes a screw bolt extended through the covering member; a rotating element connected to an outer end of the screw bolt; and a nut connected to an opposite inner end of the screw bolt; and the ornament being associated with the rotating element of the connecting unit.

3. The hubcap with ornament as claimed in claim 2, wherein the covering member is made of a material selected from the group consisting of metal materials and non-metal materials.

4. The hubcap with ornament as claimed in claim 2, wherein the rotating element is a bearing.

5. The hubcap with ornament as claimed in claim 2, wherein the screw bolt has washers fitted thereon, and the washers being located at two opposite sides of the covering member.

6. The hubcap with ornament as claimed in claim 2, wherein the ornament is associated with the rotating element in a manner selected from the group consisting of bonding, welding, and coupling to the rotating element.

7. The hubcap with ornament as claimed in claim 2, wherein the ornament has a configuration selected from the group consisting of animals, plants, numerals, characters, and geometrical patterns.
